(19) United States
(12) Patent Application Publication
(10) Pub. No.: US 2019/0036388 A1
(43) Pub. Date: Jan. 31, 2019

(54) STATOR, MOTOR, AIR BLOWER, AND METHOD OF MANUFACTURING STATOR

(71) Applicant: Nidec Corporation, Kyoto (JP)

(72) Inventors: Yuta YAMASAKI, Kyoto (JP); Yoshihisa KITAMURA, Kyoto (JP); Shoki YAMAZAKI, Kyoto (JP)

(21) Appl. No.: 16/039,377

(22) Filed: Jul. 19, 2018

(30) Foreign Application Priority Data
Jul. 28, 2017 (JP) 2017-146819

(51) Int. Cl. H02K 1/14; H02K 7/14; H02K 15/02; F04D 25/06; F04D 25/08

(52) U.S. Cl. CPC H02K 1/145; H02K 7/14; F04D 25/08; F04D 25/0646; H02K 15/022

(57) ABSTRACT

An air blower includes an impeller that rotates a vane about an axial direction, and a motor that drives the impeller. The motor includes a rotor that rotates about a central axis, and a stator that drives the rotor. The stator includes a stator core, an insulator covering the stator core, and a resin portion covering the stator core and the insulator. The stator core includes an annular core back provided about the central axis, and teeth each radially extending in one direction from the core back. The insulator includes a protruding portion provided at least on one side of the stator core in the axial direction, and radially protruding to one side with respect to the stator core. At least a portion of a side surface of the protruding portion on the one side in the radial direction defines a portion of a surface of the stator.

### CROSS REFERENCE TO RELATED APPLICATIONS

This application claims the benefit of priority to Japanese Patent Application No. 2017-146819 filed on Jul. 28, 2017. The entire contents of this application are hereby incorporated herein by reference.

### BACKGROUND OF THE INVENTION

### 1. Field of the Invention

The present disclosure relates to a stator, a motor, an air blower, and a method of manufacturing the stator.

### 2. Description of the Related Art

Motors including a stator enclosed in a molded resin material are known. For example, according to Japanese Laid-open Patent Application Publication No. 2001-268862, a stator of an electric motor is inserted in a lower block of the mold to form the stator through a molding process. In this process, the outer periphery of the stator is retained by a projection formed in the lower block to improve the accuracy of the stator bore.

To suppress a decline in torque characteristics of the motor including the stator enclosed in the molded resin material, a magnetic resistance has to be suppressed to a low level by reducing the thickness of a resin layer on the side surface of the stator, opposing a rotor, thereby reducing the distance between the stator core and the magnet in a radial direction.

However, reducing the thickness of the resin layer makes it difficult, in the process of molding the resin material over the stator, to sufficiently cover, with the resin material, the portion of the surface of the stator, where the resin layer is to be made thinner. Accordingly, a short molding becomes more prone to occur. The short molding leads to declined environmental resistance of the stator enclosed in the molded resin material.

### SUMMARY OF THE INVENTION

A stator according to a preferred embodiment of the present invention includes a stator core, an insulator covering the stator core, and a resin portion covering the stator core and the insulator. The stator core includes a core back having an annular shape and provided about a central axis, and a plurality of teeth each radially extending to one side in a radial direction from the core back. The insulator includes a protruding portion provided at least on one side of the stator core in an axial direction, and protruding to the one side with respect to the stator core in the radial direction. At least a portion of a side surface of the protruding portion on the one side in the radial direction defines a portion of a surface of the stator.

A motor according to a preferred embodiment of the present invention includes a rotor that rotates about the central axis, and the stator that drives the rotor.

An air blower according to a preferred embodiment of the present invention includes an impeller that rotates a vane about the axial direction, and the motor that drives the impeller.

A method of manufacturing a stator according to a preferred embodiment of the present invention using a mold includes placing a stator core covered with an insulator in the mold, covering the stator core and the insulator with a resin portion by injecting a resin material into the mold. The placing of the stator core includes bringing at least a portion of a side surface of the protruding portion of the insulator, on the one side in the radial direction, into contact with an inner wall of the mold.

The exemplary stators, motors, air blowers, and methods of manufacturing stators according to preferred embodiments of the present invention improve environmental resistance of the stator.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a cross-sectional view illustrating a preferred embodiment of a fan motor.

FIG. 2 is an enlarged cross-sectional view illustrating a stator.

FIG. 3 is a perspective view illustrating the stator.

FIG. 4 is a side view illustrating a preferred embodiment of the stator.

FIG. 5 is a side view illustrating another preferred embodiment of the stator.

FIG. 6 is a cross-sectional view of the stator, illustrating a preferred embodiment of a protruding portion.

FIG. 7 is a cross-sectional view of the stator, illustrating another preferred embodiment of the protruding portion.

FIG. 8A is a cross-sectional view for explaining a process of forming a resin portion.

FIG. 8B is an enlarged view of a portion surrounded by a dotted line of FIG. 8A.

### DETAILED DESCRIPTION OF THE PREFERRED EMBODIMENTS

Hereafter, an exemplary embodiment of the present disclosure will be described with reference to the drawings.

For the description given hereinafter, a direction parallel to a central axis CA in a fan motor 100 will be defined as “axial direction”. Regarding the axial direction, the side of a bush 11 from a lid 261b, which will both be subsequently described, will be defined as “axially upper side”, as one side in the axial direction, and the side of the lid 261b from the bush 11 will be defined as “axially lower side”, as the other side in the axial direction. Regarding each of constituent elements, and end portion on the axially upper side will be defined as “upper end portion”, and an end portion on the axially lower side will be defined as “lower end portion”. In addition, regarding the surface of each of the constituent elements, a face oriented upward in the axial direction will be defined as “upper face”, and a face oriented downward in the axial direction will be defined as “lower face”.

Further, a direction orthogonal to the central axis CA will be defined as “radial direction”, and a direction along a circumference about the central axis CA will be defined as “circumferential direction”. Regarding the radial direction, a direction toward the central axis CA will be defined as “radially inward”, and a direction away from the central axis CA will be defined as “radially outward”. Regarding each of the constituent elements, an end portion on the radially inner side will be defined as “inner end portion”, and an end portion on the radially outer side will be defined as “outer end portion”. Regarding the side surface of each of the constituent elements, a side surface oriented radially inward will be defined as “inner side surface”, and a side surface oriented radially outward will be defined as “outer side surface”.

The mentioned definitions of the directions, end portions, faces, and the like do not necessarily represent the positional relations, directions, and the like of the elements that are actually incorporated in an assembly.

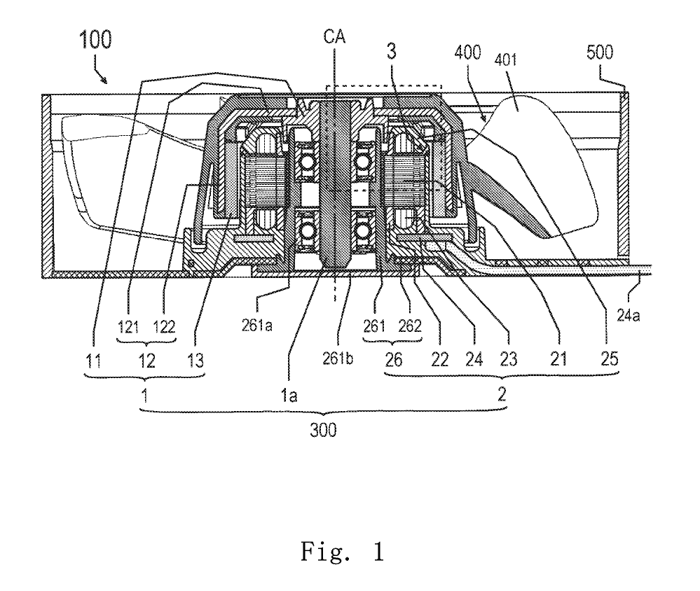

FIG. 1 is a cross-sectional view illustrating an example of a fan motor 100. FIG. 1 illustrates a cross-sectional structure of the fan motor 100, including the central axis CA.

The fan motor 100 is an air blower, and includes an outer-rotor motor 300, an impeller 400, and a casing 500, as illustrated in FIG. 1. The motor 300 serves as a driver for rotating the impeller 400. The impeller 400 is a vaned wheel having a plurality of vanes 401. The impeller 400 is configured to rotate about the axial direction, interlocked with the plurality of vanes 401. The impeller 400 is mounted on the upper side of the motor 300 in the axial direction. The impeller 400 is made to rotate by the motor 300 about the central axis CA, to generate an airflow proceeding in the axial direction. The casing 500 accommodates therein the motor 300 and the impeller 400.

Although the fan motor 100 is an axial flow fan in the embodiment, the fan motor 100 may be a centrifugal fan. In other words, the fan motor 100 may be configured to generate an airflow proceeding radially outward. In addition, although the motor 300 is an outer-rotor motor in the embodiment, the motor 300 may be an inner-rotor motor.

The configuration of the motor 300 will be described hereunder. As illustrated in FIG. 1, the motor 300 includes a rotor 1, a shaft 1a, and a stator 2.

The rotor 1 is set to rotate with respect to the stator 2 about the central axis CA extending in the up-down direction. The rotor 1 includes a bush 11, a magnet holder 12, and a magnet 13. The bush 11 is attached to the shaft 1a, at the upper end portion of the motor 300. The magnet holder 12 serves to retain the magnet 13. The magnet holder 12 includes a plate-shaped portion 121 and a cylindrical portion 122. The plate-shaped portion 121 is an annular member extending radially outward from the bush 11. The cylindrical portion 122 has a cylindrical shape, and extends at least axially downward from the outer end portion of the plate-shaped portion 121. The magnet 13 is retained by the inner side surface of the cylindrical portion 122 at a position on the radially outer side of the stator 2, and opposed to the outer side surface of the stator 2.

The shaft 1a serves as the rotation shaft of the rotor 1. The shaft 1a supports the rotor 1, and rotates interlocked with the rotor 1, about the central axis CA. Here, the shaft 1a may be a fixed shaft attached to the stator 2. In this case, however, a non-illustrated bearing is provided between the rotor 1 and the shaft 1a.

The stator 2 is a stationary portion retained by the casing 500, having an annular shape located about the central axis CA. The stator 2 supports the rotor 1, and rotates the rotor 1 thus to drive the motor 300.

The stator 2 includes a stator core 21, an insulator 22, a plurality of coil portions 23, a substrate 24, a resin portion 25, a fixing element 26, a bearing 261a, and a lid 261b. The stator 2 is fixed to the casing 500, via a fixing element 26.

The stator core 21 is an iron core fixed to the radially outer side of a bearing holder 261 of the fixing element 26, to be subsequently described, and opposed to the magnet 13 of the rotor 1 in the radial direction. Further details of the stator core 21 will be subsequently described.

The insulator 22 is an insulating member, for example formed of a resin material, and covers at least a part of the stator core 21. The insulator 22 includes a protruding portion 3. To be more detailed, the stator 2 includes the insulator 22, and the insulator 22 includes the protruding portion 3. Further details of the protruding portion 3 will be subsequently described.

The plurality of coil portions 23 each include a conductor wire wound around the stator core 21, via the insulator 22.

The substrate 24 is electrically connected to the conductor wire of the coil portion 23 and a lead wire 24a drawn out from the casing 500. For example, a driver device for the stator 2 is mounted on the substrate 24. The substrate 24 is located on the lower side with respect to the stator core 21 in the axial direction.

The resin portion 25, which covers at least a part of the stator 2, also covers the stator core 21 and the insulator 22, for example. The resin portion 25 can be formed, for example, by molding the resin material over the stator core 21 and the insulator 22. The formation process of the resin portion 25 will be subsequently described.

The fixing element 26 serves to fix the stator 2 to the casing 500. The fixing element 26 includes a bearing holder 261 and an attaching portion 262. In other words, the stator 2 includes the bearing holder 261 and the attaching portion 262.

The bearing holder 261 is a cylindrical portion supporting the stator 2. Inside the bearing holder 261, the bearing 261a is provided, and also the shaft 1a is inserted. The bearing holder 261 supports the shaft 1a via the bearing 261a, so as to allow the shaft 1a to rotate. Although the bearing 261a is a ball bearing in the embodiment, the bearing 261a may be, for example, a sleeve bearing. In addition, the lid 261b is fitted in the lower end portion of the bearing holder 261. In other words, the lid 261b covers the lower end portion of the bearing holder 261.

The attaching portion 262 has an annular shape, and serves to fix the stator 2 to the casing 500. To be more detailed, the attaching portion 262 fixes the stator 2 to the casing 500 which accommodates the stator 2 therein. The bearing holder 261 is attached to the inner end portion of the attaching portion 262. The outer end portion of the attaching portion 262 is attached to the casing 500. Further, at least a part of the attaching portion 262 is covered with the resin portion 25.

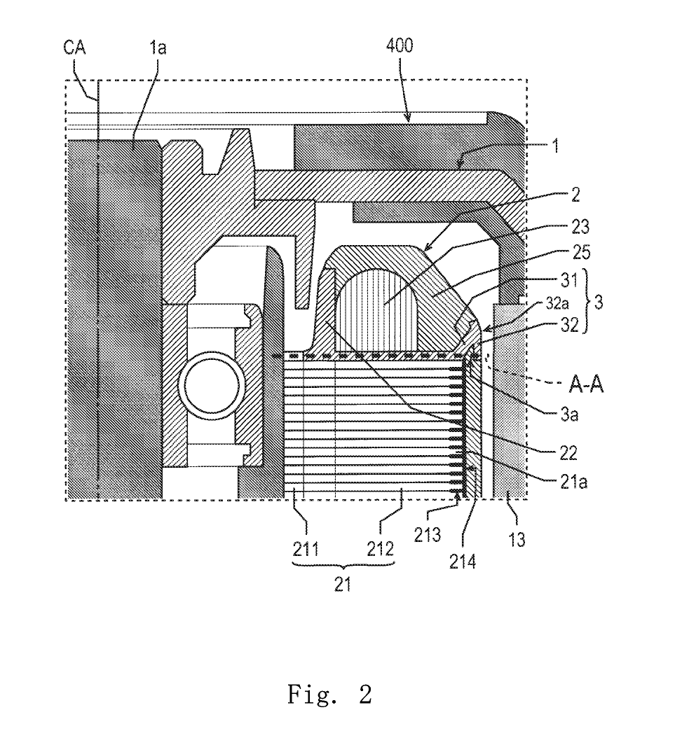

The configuration of the stator core 21 will now be described. FIG. 2 is an enlarged cross-sectional view illustrating a stator. FIG. 2 corresponds to a cross-section of a portion enclosed by a broken line in FIG. 1.

The stator core 21 is composed of a plurality of steel plates 21a stacked in the axial direction, thus formed into laminated steel plates. Each of the steel plates 21a is, for example, an electromagnetic steel plate. The stator core 21 includes a core back 211 and a plurality of teeth 212. The core back 211 has an annular shape located about the central axis CA, and is fixed on the radially outer side of the bearing holder 261. The plurality of teeth 212 each extend radially outward from the core back 211, and opposed to the magnet 13 in the radial direction.

The stator core 21 also includes a filler 213 and a cover film 214. In other words, the stator 2 includes the filler 213 and the cover film 214. The filler 213 is loaded between the steel plates 21a, at the outer end portion of the laminated steel plates. The cover film 214 covers at least the outer side surface of the stator core 21. The filler 213 and the cover film 214 contribute to improving the environmental resistance of the stator core 21.

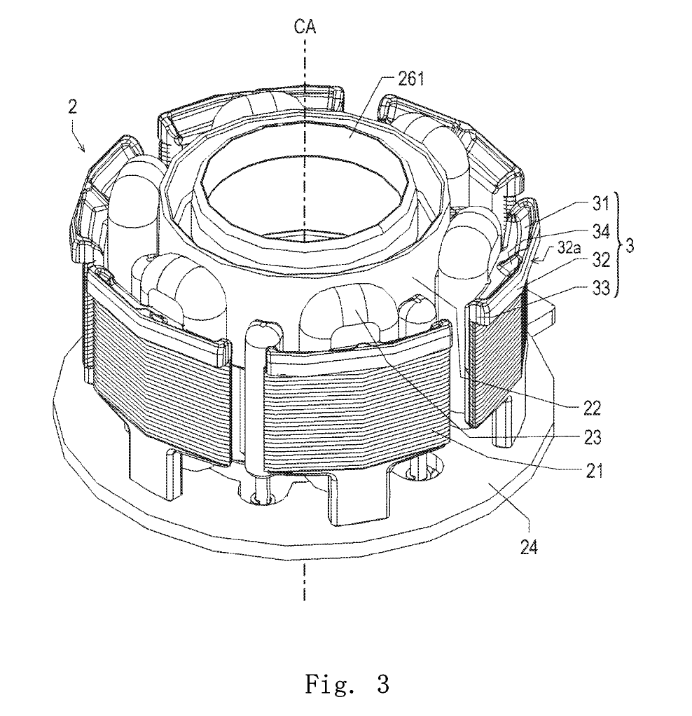

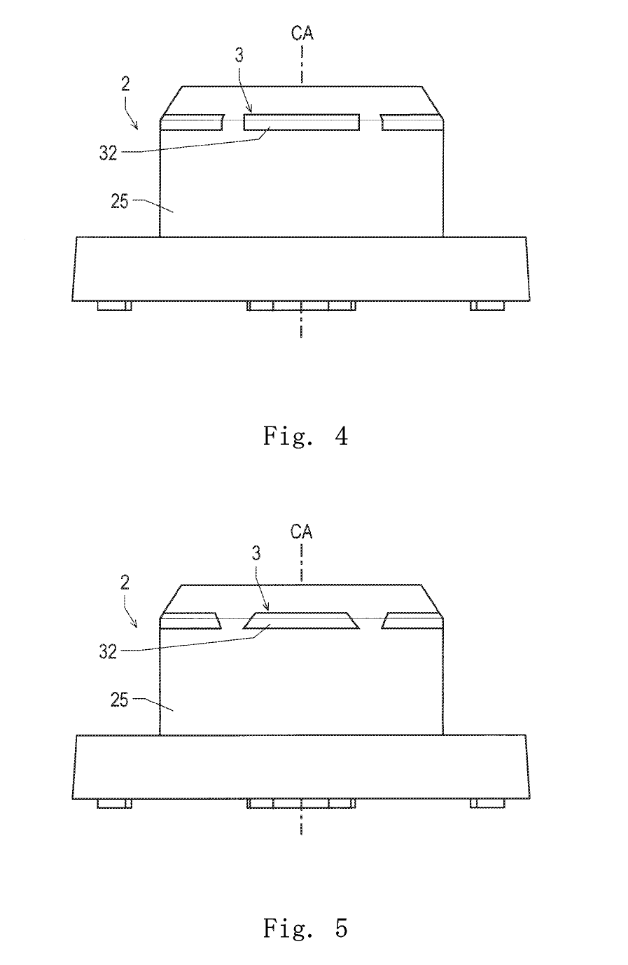

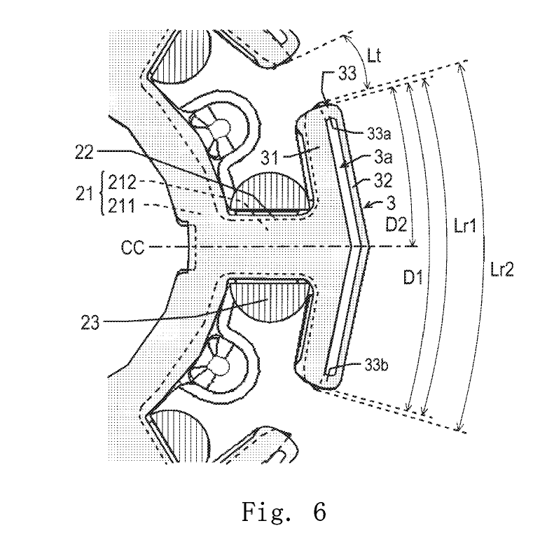

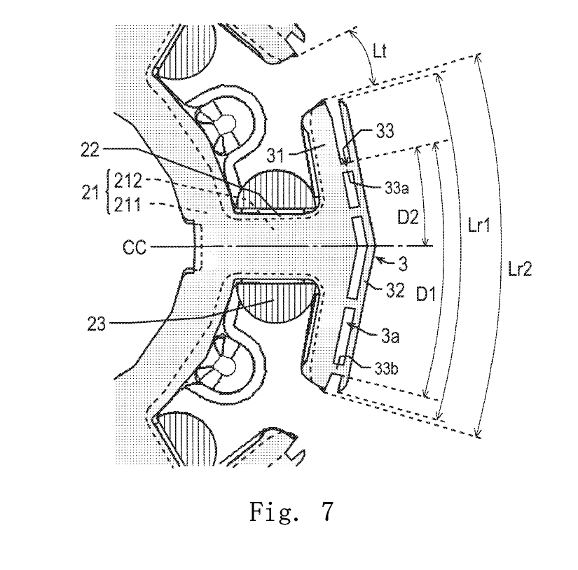

Referring now to FIG. 2 to FIG. 7, the configuration of the protruding portion 3 will be described. FIG. 3 is a perspective view illustrating the stator 2. FIG. 4 is a side view illustrating an example of the stator 2. FIG. 5 is a side view illustrating another example of the stator 2. FIG. 6 is a cross-sectional view of the stator 2, illustrating an example of the protruding portion 3. FIG. 7 is a cross-sectional view of the stator 2, illustrating another example of the protruding portion 3. In FIG. 3, the resin portion 25 is omitted for the sake of clarity. FIG. 6 and FIG. 7 correspond to a cross-section taken along a broken line A-A in FIG. 2.

As illustrated in FIG. 3, the protruding portion 3 protrudes radially outward with respect to the stator core 21, from the upper side of the stator core 21 in the axial direction. At least a part of an outer side surface 32a of the protruding portion 3, to be subsequently described, and also the surface of the resin portion 25, constitute a part of the surface of the stator 2. In the case where the surface of the stator 2 on the radially outer side is not covered with a coating material, the outer side surface 32a and the resin portion 25 constitute the surface of the stator 2 exposed to outside, as illustrated in FIG. 2. However, when the surface of the stator 2 on the radially outer side is covered with a coating material, for example a water-proof film such as a parylene coating, the mentioned surface of the stator 2 corresponds to the interface between the stator 2 and the coating material.

With the mentioned configuration, a part of the flow of the resin material in the axial direction can be blocked by the protruding portion on the upper side of the stator core 21 in the axial direction, when the resin portion 25 is to be formed by molding the resin material, for example using a mold 700 to be subsequently described. Accordingly, the resin material first flows with preference to a region other than the interface between the insulator 22, which includes the protruding portion 3, and the upper end portion of the stator core 21, and then flows toward the mentioned interface. At the interface, air can escape through between the insulator 21 and the upper end portion of the stator core 22. Therefore, the interface can be covered with the resin portion 25, since the air can be restrained or prevented from residing in the vicinity of the interface. Further, generation of a portion where the resin portion 25 fails to be formed, due to a phenomenon called short molding, as well as a vulnerable portion of the resin portion 25, known as weld, can be restrained or prevented. Therefore, a decline in adhesion strength, deformation, separation, and the like of the resin portion 25 can be suppressed. Consequently, the environmental resistance of the stator 2 can be improved.

Without limitation to the foregoing configuration, the protruding portion 3 may be formed so as to protrude from the lower side of the stator core 21 in the axial direction. In other words, it suffices that the protruding portion 3 protrudes radially outward with respect to the stator core 21, at least from one side of the stator core 21 in the axial direction.

A circumferential length Lr1 of the protruding portion 3 is equal to or longer than 50% of a circumferential length Lr2 of the outer end portion of the teeth 212 of the stator core 21. Regarding the upper limit of the circumferential length Lr1 of the protruding portion 3, it suffices that a gap is secured between the protruding portions 3 adjacent to each other in the circumferential direction. The circumferential length Lr1 of the protruding portion 3 may be, for example, shorter than a sum of the circumferential length Lr2 of the outer end portion of the teeth 212 and a circumferential length Lt of the teeth 212 adjacent to each other (Lr2+Lt).

Defining the circumferential length Lr1 of the protruding portion 3 as above allows, when molding the resin material into the resin portion 25, the resin material to reach the interface between the insulator 22 including the protruding portion 3 and the upper end portion of the stator core 21, after covering the region other than the mentioned interface with the resin material flowing axially downward through between the protruding portions 3. Accordingly, air can be restrained or prevented from residing in the vicinity of the interface, and therefore the short molding can be more securely restrained or prevented.

Further, the protruding portion 3 includes a joint portion 31, a wall portion 32, a recessed portion 3a extending in the circumferential direction, a plurality of first ribs 33, and a second rib 34.

The joint portion 31 extends axially upward and radially outward, from the upper side of the stator core 21 in the axial direction.

The wall portion 32 is located along the outer end portion of the joint portion 31. At least a part of the wall portion 32 is located on the radially outer side with respect to the stator core 21. In addition, at least a part of an outer side surface 32a of the wall portion 32 constitutes a part of the surface of the stator 2. With the mentioned configuration, at least a part of the outer side surface 32a of the wall portion 32 is made to contact the inner wall of the mold 700, in the molding process of the resin material. When the joint portion 31 blocks a part of the axially downward flow of the resin material, the joint portion 31 and the wall portion 32 are pressed axially downward, so that the outer side surface 32a of the wall portion 32 makes a closer contact with the inner wall of the mold 700. Thus, the joint portion 31 and the wall portion 32 can more effectively restrain the resin material from flowing in the axial direction.

The wall portion 32 has a rectangular shape when viewed in the radial direction (see FIG. 4). Such a shape allows a sufficient circumferential length of the wall portion 32 to be secured, without largely extending the wall portion 32 axially upward. Alternatively, the wall portion 32 may have, for example, a trapezoidal shape having the short side on the axially upper side and the long side on the axially lower side (see FIG. 5), when viewed in the radial direction. In this case, although the resin material flowing axially downward collides with the short side of the wall portion 32 of the trapezoidal shape, the resin material can continue to flow along the hypotenuse of the wall portion 32 of the trapezoidal shape. Accordingly, the force to which the wall portion 32 is subjected can be reduced, and the protruding portion 3 can be restrained from being deformed.

The recessed portion 3a is formed in the lower end portion of the protruding portion 3, so as to recede axially upward from the axially lower side. The recessed portion 3a is filled with a part of the resin portion 25. Such a configuration restrains the resin portion 25 from being separated radially outward. In particular, a part of the resin portion 25 that is relatively thin, covering the outer side surface of the stator core 21 on the axially lower side of the protruding portion 3, can be restrained from being deformed or separated, for example.

The first ribs 33 are each formed in the recessed portion 3a, so as to extend axially downward and radially outward, from the inner wall of the recessed portion 3a. Forming the first ribs 33 in the recessed portion 3a leads to improvement in strength of the protruding portion 3. Accordingly, the protruding portion 3 can be restrained or prevented from being broken or deformed, for example, in the process of molding the resin material into the resin portion 25, using the mold 700. In addition, the first ribs 33 are buried in the resin portion 25 after the resin material is molded, and therefore the adhesion strength between the protruding portion 3 and the resin portion 25 can be improved.

To be more detailed, the first ribs 33 are respectively formed at one end portion and the other end portion of the recessed portion 3a, in the circumferential direction (see FIG. 6). Such a configuration leads to improvement in strength of the protruding portion 3. In addition, when the resin material is molded into the resin portion 25, the resin material flowing into the recessed portion 3a from the lower end portion of the recessed portion 3a can easily fill in the recessed portion 3a. In contrast, it is difficult for the resin material, flowing into the recessed portion 3a from the circumferential end portions thereof, to fill in the recessed portion 3a. Accordingly, the recessed portion 3a of the protruding portion 3 can be sufficiently filled with the resin material from the axially lower side, by preventing the resin material from flowing in from the circumferential end portions. Thus, the adhesion strength between the recessed portion 3a and the resin portion 25 can be improved.

Further, the first rib 33 may also be formed between the one end portion and the other end portion of the recessed portion 3a in the circumferential direction. In other words, the first rib 33 may also be formed inside the recessed portion 3a, at a position spaced from the circumferential end portions of the recessed portion 3a. In this case, the strength of the protruding portion 3 can be further improved.

Alternatively, the first ribs 33 may be formed, instead of at the respective circumferential end portions of the recessed portion 3a, at positions between the one circumferential end portion and the other circumferential end portion of the recessed portion 3a (see FIG. 7). In this case also, the strength of the protruding portion 3 can be improved. In addition, blocking the resin material flowing into the regions between the plurality of first ribs 33 in the circumferential direction allows the resin material flowing in from the axially lower side to be filled in the recessed portion 3a of the protruding portion 3, with preference. Therefore, the adhesion strength between the recessed portion 3a and the resin portion 25 can be improved.

In each of the teeth 212, a distance D1 in the circumferential direction between the farther end portion of a first rib 33a located at one circumferentially farthest position, and the farther end portion of a first rib 33b located at the other circumferentially farthest position, is equal to or longer than 50% of the circumferential length Lr2 of the outer end portion of the teeth 212 (see FIG. 6 and FIG. 7).

Further, in each of the teeth 212, the first rib 33a located at the one circumferentially farthest position is closer to a center CC of the protruding portion 3 in the circumferential direction than the first rib 33b located at the other circumferentially farthest position. In addition, a distance D2 in the circumferential direction between the center CC of the protruding portion 3 in the circumferential direction, and the farther end portion of the first rib 33a located at the one circumferentially farthest position, is equal to or longer than 25% of the circumferential length Lr2 of the outer end portion of the teeth 212, and equal to or shorter than half the circumferential length Lr1 of the protruding portion 3 {(½)Lr1} (see FIG. 6 and FIG. 7). Such a configuration restrains the farther end portion of the first rib 33a located at the one circumferentially farthest position from being excessively distant from the one circumferential end portion of the protruding portion 3.

Defining the distances D1 and D2 as above effectively restrains, when molding the resin material into the resin portion 25, the resin material from flowing into the recessed portion 3a from the circumferential end portions of the recessed portion 3a. Accordingly, the resin material can reach the interface between the insulator 22 including the protruding portion 3 and the upper end portion of the stator core 21, after the region other than the mentioned interface is covered with the resin material flowing axially downward through between the protruding portions 3. Therefore, air can be restrained or prevented from residing in the vicinity of the interface, and consequently the short molding can be more securely restrained or prevented.

The second rib 34 extends axially upward from the joint portion 31, and is connected to the wall portion 32 on the radially outer side. Such a configuration further improves the strength of the protruding portion 3, thereby restraining the deformation thereof. In addition, the resin material restrained from flowing in by the first rib 33a presses the protruding portion 3 radially outward, which brings the protruding portion 3 and the mold 700 into closer contact with each other. Therefore, the resin material can be more effectively restrained from flowing in the axial direction.

Hereunder, an example of the method of manufacturing the stator 2 with the mold 700 will be described. The method of manufacturing the stator 2 includes forming the stator core 21, forming the insulator 22, forming the coil portion 23, mounting the substrate 24, fixing the stator core 21, and forming the resin portion 25.

First, a plurality of steel plates 21a are stacked in the axial direction to form the stator core 21 composed of the laminated steel plates. The forming of the insulator 22 includes covering at least a part of the stator core 21 with the insulator 22, and forming the protruding portion 3. To form the coil portion 23, a conductor wire is wound around each of the teeth 212 of the stator core 21, via the insulator 22. The substrate 24 is mounted on the axially lower side of the stator core 21. In the fixing of the stator core 21, the stator core 21 is fixed to the bearing holder 261 of the fixing element 26.

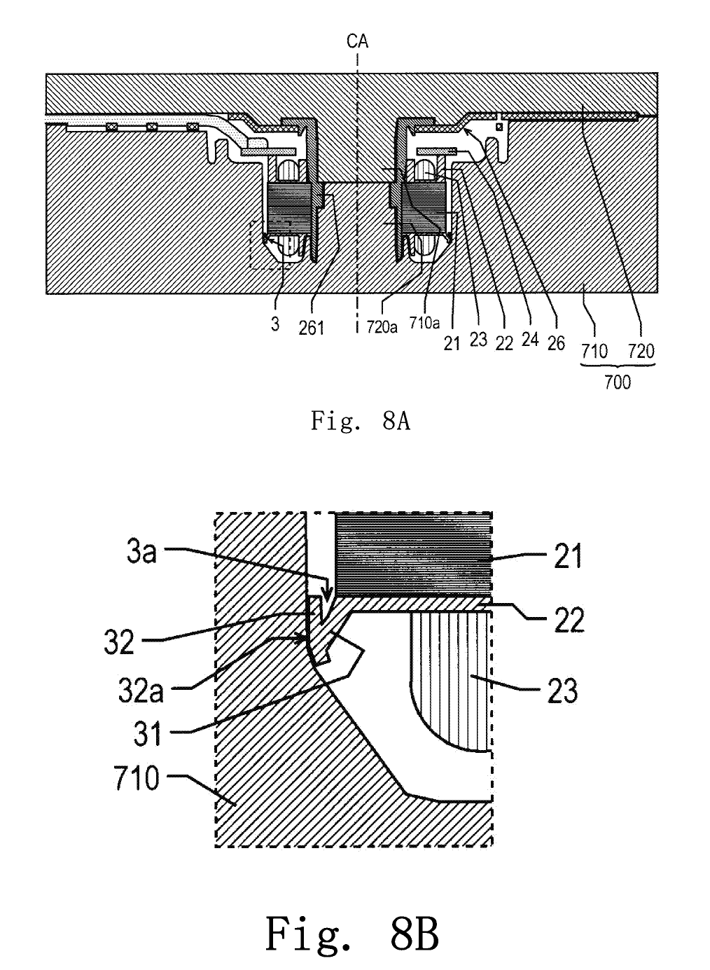

To form the resin portion 25, the resin material is molded into the resin portion 25 in the mold 700, including a lower mold 710 and an upper mold 720. The forming of the resin portion 25 includes placing the stator core 21 in the mold 700, and molding the resin material in the mold 700. FIG. 8A and FIG. 8B are a cross-sectional view for explaining the process for forming the resin portion 25. It should be noted that the upper and lower sides in the axial direction in FIG. 8 A and FIG. 8B are inverted from FIG. 1 to FIG. 5. In other words, the axially lower side in FIG. 8 A and FIG. 8B correspond to the axially upper side in FIG. 1 to FIG. 5, and the axially upper side in FIG. 8 A and FIG. 8B correspond to the axially lower side in FIG. 1 to FIG. 5.

When the stator core 21 is placed in the mold 700, the stator core 21 covered with the insulator 22 is placed in the mold 700. At this point, at least a part of the outer side surface 32a of the protruding portion 3, included in the insulator 22, is made to contact the inner wall of the mold 700. Then the resin material is injected into the mold 700, so that, for example, the stator core 21 and the insulator 22 are covered with the resin portion 25.

To be more detailed, first the stator 2, not yet including the resin portion 25, is placed inside the lower mold 710. At this point, the upper end portion of the bearing holder 261 in the axial direction is covered with a projection 710a of the lower mold 710. In addition, at least a part of the outer side surface 32a of the wall portion 32 is made to contact the inner wall of the lower mold 710.

Then the upper end portion of the lower mold 710 is closed by the upper mold 720. In this process, the lower end portion of the bearing holder 261 in the axial direction is covered with a projection 720a of the upper mold 720.

The resin material is then injected from a non-illustrated injection port of the mold 700, into between the lower mold 710 and the upper mold 720, so as to fill in the space therebetween. When the resin material is cured, for example, the stator core 21 and the insulator 22 are covered with the resin portion 25.

Upon opening the upper mold 720 and the lower mold 710 upward and downward respectively, the stator 2 can be obtained.

In the mentioned forming process of the resin portion 25, since at least a part of the outer side surface 32a of the protruding portion 3 is in contact with the inner wall of the mold 700, the protruding portion 3 blocks a part of the axially upward flow of the resin material, on the axially upper side of the stator core 21, when the resin material is injected into the mold 700. Accordingly, the resin material first flows with preference to a region other than the interface between the insulator 22, which includes the protruding portion 3, and the upper end portion of the stator core 21, and then flows toward the mentioned interface. At the interface, air can escape through between the insulator 21 and the upper end portion of the stator core 22. Therefore, the interface can be covered with the resin portion 25, since the air can be restrained or prevented from residing in the vicinity of the interface. Further, generation of a portion where the resin portion 25 fails to be formed, due to the phenomenon called short molding, as well as a vulnerable portion of the resin portion 25, known as weld, can be restrained or prevented. Therefore, a decline in adhesion strength, deformation, separation, and the like of the resin portion 25 can be suppressed. Consequently, the environmental resistance of the stator 2 can be improved.

According to the foregoing embodiment, the stator 2 includes the stator core 21, the insulator 22 covering the stator core 21, and the resin portion 25 covering the stator core 21 and the insulator 22. The stator core 21 includes the core back 211 having an annular shape and provided about the central axis CA, and the plurality of teeth 212 each radially extending in one direction from the core back 211. The insulator 22 includes the protruding portion 3 formed at least on the upper side of the stator core 21 in the axial direction, and protruding to one side in the radial direction, with respect to the stator core 21. At least a part of the side surface 32a of the protruding portion 3 on the one side in the radial direction constitutes a part of the surface of the stator 2. In the mentioned configuration, the one side in the radial direction corresponds to the radially outer side, when the motor 300 is an outer-rotor motor as in the embodiment, but corresponds to the radially inner side, when the motor 300 is an inner-rotor motor.

With the mentioned configuration, when the resin portion 25 is to be formed by molding the resin material on, for example, the stator core 21 and the insulator 22 using the mold 700, the protruding portion 3 blocks a part of the axially upward flow of the resin material, on the axially upper side of the stator core 21. Accordingly, the resin material first flows with preference to a region other than the interface between the insulator 22 including the protruding portion 3, and the upper end portion of the stator core 21, and then flows toward the mentioned interface. At the interface, air can escape through between the insulator 21 and the upper end portion of the stator core 22. Therefore, the interface can be covered with the resin portion 25, since the air can be restrained or prevented from residing in the vicinity of the interface. Further, generation of a portion where the resin portion 25 fails to be formed, due to the phenomenon called short molding, as well as a vulnerable portion of the resin portion 25, known as weld, can be restrained or prevented. Therefore, a decline in adhesion strength, deformation, separation, and the like of the resin portion 25 can be suppressed. Consequently, the environmental resistance of the stator 2 can be improved.

According to the embodiment, the circumferential length Lr1 of the protruding portion 3 is equal to or longer than 50% of the circumferential length Lr2 of the end portion of the teeth 212 in the radial direction. Regarding the upper limit of the circumferential length Lr1, it suffices that a gap is secured between the protruding portions 3 adjacent to each other in the circumferential direction. The circumferential length Lr1 may be, for example, shorter than a sum of the circumferential length Lr2 and the circumferential length Lt of the teeth 212 adjacent to each other (Lr2+Lt), or may be shorter than a sum of the circumferential length Lr2 and half the circumferential length Lt {Lr2+(½)Lt}. In the mentioned configuration, the one end portion of the teeth 212 in the radial direction corresponds to the outer end portion of the teeth 212, when the motor 300 is an outer-rotor motor as in the embodiment, but corresponds to the inner end portion of the teeth 212, when the motor 300 is an inner-rotor motor.

Defining the circumferential length Lr1 of the protruding portion 3 as above allows, when molding the resin material into the resin portion 25, the resin material to reach the interface between the insulator 22 including the protruding portion 3 and the upper end portion of the stator core 21, after covering the region other than the mentioned interface with the resin material flowing axially downward through between the protruding portions 3. Accordingly, air can be restrained or prevented from residing in the vicinity of the interface, and therefore the short molding can be more securely restrained or prevented.

According to the embodiment, the protruding portion 3 includes the recessed portion 3a, receding axially upward from the axially lower side of the protruding portion 3. The recessed portion 3a is filled with a part of the resin portion 25.

Filling the recessed portion 3a, receding axially upward, with a part of the resin portion 25 restrains the resin portion 25 from being separated in the radial direction. In particular, a part of the resin portion 25 that is relatively thin, covering the outer side surface of the stator core 21 opposed to the magnet 13 in the radial direction on the axially lower side of the protruding portion 3, can be restrained from being deformed or separated, for example.

According to the embodiment, the recessed portion 3a extends in the circumferential direction. The protruding portion 3 includes the plurality of first ribs 33 each extending in the radial direction. The plurality of first ribs 33 are located in the recessed portion 3a.

Providing the plurality of first ribs 33 in the recessed portion 3a leads to improvement in strength of the protruding portion 3. Accordingly, for example, the protruding portion 3 can be restrained or prevented from being broken or deformed, in the process of molding the resin material into the resin portion 25 using the mold 700.

According to the embodiment, the first ribs 33 are respectively formed at one end portion and the other end portion of the recessed portion 3a, in the circumferential direction.

The mentioned configuration leads to improvement in strength of the protruding portion 3. In addition, when the resin material is molded into the resin portion 25, the resin material flowing into the recessed portion 3a from the lower end portion of the recessed portion 3a can easily fill in the recessed portion 3a. In contrast, it is difficult for the resin material, flowing into the recessed portion 3a from the circumferential end portions thereof, to fill in the recessed portion 3a. Accordingly, the recessed portion 3a of the protruding portion 3 can be sufficiently filled with the resin material from the axially lower side, by restraining the resin material from flowing in from the circumferential end portions. Thus, the adhesion strength between the recessed portion 3a and the resin portion 25 can be improved.

According to the embodiment, the first rib 33 may also be formed between the one end portion and the other end portion of the recessed portion 3a in the circumferential direction.

In this case, the strength of the protruding portion 3 can be improved. In addition, blocking the resin material flowing into the regions between the plurality of first ribs 33 in the circumferential direction allows the resin material flowing in from the axially lower side to be filled in the recessed portion 3a of the protruding portion 3, with preference. Therefore, the adhesion strength between the recessed portion 3a and the resin portion 25 can be improved.

According to the embodiment, in each of the teeth 212, the distance D1 in the circumferential direction between the first rib 33a located at one circumferentially farthest position, and the first rib 33b located at the other circumferentially farthest position, is equal to or longer than 50% of the circumferential length Lr2 of the end portion of the teeth 212 on one side in the radial direction. The distance D1 is equal to or shorter than the circumferential length Lr1 of the protruding portion 3. In the mentioned configuration, the one end portion of the teeth 212 in the radial direction corresponds to the outer end portion of the teeth 212, when the motor 300 is an outer-rotor motor as in the embodiment, but corresponds to the inner end portion of the teeth 212, when the motor 300 is an inner-rotor motor.

According to the embodiment, in each of the teeth 212, the first rib 33a located at the one circumferentially farthest position is closer to the center CC of the protruding portion 3 in the circumferential direction than the first rib 33b located at the other circumferentially farthest position. In addition, the distance D2 in the circumferential direction between the center CC of the protruding portion 3 in the circumferential direction, and the farther end portion of the first rib 33a located at the one circumferentially farthest position, is equal to or longer than 25% of the circumferential length Lr2 of the end portion of the teeth 212 on one side in the radial direction. The distance D2 is equal to or shorter than half the circumferential length Lr1 of the protruding portion 3 {(½)Lr1}. In the mentioned configuration, the one end portion of the teeth 212 in the radial direction corresponds to the outer end portion of the teeth 212, when the motor 300 is an outer-rotor motor as in the embodiment, but corresponds to the inner end portion of the teeth 212, when the motor 300 is an inner-rotor motor. Such a configuration restrains the farther end portion of the first rib 33a located at the one circumferentially farthest position from being excessively distant from the one circumferential end portion of the protruding portion 3.

Defining the distances D1 and D2 as above effectively restrains, when molding the resin material into the resin portion 25, the resin material from flowing into the recessed portion 3a from the circumferential end portions of the recessed portion 3a. Accordingly, the resin material can reach the interface between the insulator 22 including the protruding portion 3 and the upper end portion of the stator core 21, after the region other than the mentioned interface is covered with the resin material flowing axially downward through between the protruding portions 3. Therefore, air can be restrained or prevented from residing in the vicinity of the interface, and consequently the short molding can be more securely restrained or prevented.

According to the embodiment, the protruding portion 3 includes the joint portion 31 extending axially upward and radially outward, at least from the upper side of the stator core 21 in the axial direction, and the wall portion 32 located along the end portion of the joint portion 31 on one side in the radial direction. At least a part of the wall portion 32 is located on one side with respect to the stator core 21 in the radial direction. At least a part of the side surface 32a of the wall portion 32 on one side in the radial direction constitutes a part of the surface of the stator 2. In the mentioned configuration, the one side in the radial direction corresponds to the radially outer side, when the motor 300 is an outer-rotor motor as in the embodiment, but corresponds to the radially inner side, when the motor 300 is an inner-rotor motor.

With the mentioned configuration, the joint portion 31 blocks a part of the flow of the resin material in the axial direction, on the axially upper side of the stator core 21, in the process of molding the resin material into the resin portion 25, using the mold 700. In addition, at least a part of the side surface of the wall portion 32 on one side in the radial direction is made to contact the inner wall of the mold 700, in the molding process. When the joint portion 31 blocks a part of the axially downward flow of the resin material, the joint portion 31 and the wall portion 32 are pressed axially downward, so that the outer side surface 32a of the wall portion 32 makes a closer contact with the inner wall of the mold 700. Thus, the joint portion 31 and the wall portion 32 can more effectively restrain the resin material from flowing in the axial direction.

According to the embodiment, the protruding portion 3 includes the second rib 34 extending axially upward from the joint portion 31. The second rib 34 is connected to the wall portion 32, on one side in the radial direction. In the mentioned configuration, the one side in the radial direction corresponds to the radially outer side, when the motor 300 is an outer-rotor motor as in the embodiment, but corresponds to the radially inner side, when the motor 300 is an inner-rotor motor.

The mentioned configuration further improves the strength of the protruding portion 3.

According to the embodiment, the wall portion 32 has a rectangular shape when viewed in the radial direction.

The mentioned shape allows a sufficient circumferential length of the wall portion 32 to be secured, without largely extending the wall portion 32 axially upward.

According to the embodiment, the wall portion 32 may have, for example, a trapezoidal shape having the short side on the axially upper side and the long side on the axially lower side, when viewed in the radial direction.

In this case, although the resin material flowing axially downward collides with the short side of the wall portion 32 of the trapezoidal shape, the resin material can continue to flow along the hypotenuse of the trapezoid. Accordingly, the force to which the wall portion 32 is subjected can be reduced, and the protruding portion 3 can be restrained from being deformed.

According to the embodiment, the stator core 21 is composed of a plurality of steel plates 21a stacked in the axial direction, thus formed into laminated steel plates. The stator 2 includes the filler 213 loaded between the steel plates 21a, at the end portion of the laminated steel plates on one side in the radial direction. In the mentioned configuration, the end portion of the laminated steel plates on the one side in the radial direction corresponds to the outer end portion thereof, when the motor 300 is an outer-rotor motor as in the embodiment, but corresponds to the inner end portion of the laminated steel plates, when the motor 300 is an inner-rotor motor.

According to the embodiment, the stator 2 also includes the cover film 214 covering at least the side surface of the stator core 21 on one side in the radial direction. In the mentioned configuration, the side surface on the one side in the radial direction corresponds to the outer side surface, when the motor 300 is an outer-rotor motor as in the embodiment, but corresponds to the inner side surface, when the motor 300 is an inner-rotor motor.

The configurations thus far described contribute to further improving the environmental resistance of the stator core 21.

According to the embodiment, the motor 300 includes the rotor 1 that rotates about the central axis CA, and the stator 2 that drives the rotor 1.

The mentioned configuration improves the environmental resistance of the motor 300.

According to the embodiment, the fan motor 100 is an air blower including the impeller 400 that rotates the vane 401 about the axial direction, and the motor 300 that drives the impeller 400.

The mentioned configuration improves the environmental resistance of the fan motor 100.

According to the embodiment, the method of manufacturing the stator 2 using the mold 700 includes placing the stator core 21 covered with the insulator 22 in the mold 700, covering the stator core 21 and the insulator 22 with the resin portion 25 by injecting a resin material into the mold 700. In the placing of the stator core 21, at least a part of the side surface 32a of the protruding portion 3 of the insulator 22, on one side in the radial direction, is made to contact the inner wall of the mold 700. In the mentioned method, the side surface 32a of the protruding portion 3 on the one side in the radial direction corresponds to the outer side surface 32a, when the motor 300 is an outer-rotor motor as in the embodiment, but corresponds to the inner side surface, when the motor 300 is an inner-rotor motor.

With the mentioned arrangement, since at least a part of the side surface 32a of the protruding portion 3, on the one side in the radial direction, is in contact with the inner wall of the mold 700, the protruding portion 3 blocks a part of the axially upward flow of the resin material, on the axially upper side of the stator core 21, when the resin material is injected into the mold 700. Accordingly, the resin material first flows with preference to a region other than the interface between the insulator 22, which includes the protruding portion 3, and the upper end portion of the stator core 21, and then flows toward the mentioned interface. At the interface, air can escape through between the insulator 21 and the upper end portion of the stator core 22. Therefore, the interface can be covered with the resin portion 25, since the air can be restrained or prevented from residing in the vicinity of the interface. Further, generation of a portion where the resin portion 25 fails to be formed, due to the phenomenon called short molding, as well as a vulnerable portion of the resin portion 25, known as weld, can be restrained or prevented. Therefore, a decline in adhesion strength, deformation, separation, and the like of the resin portion 25 can be suppressed. Consequently, the environmental resistance of the stator 2 can be improved.

The present disclosure is broadly applicable to, for example, motors including a stator enclosed in a molded resin portion, and air blowers.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A stator that drives a rotor, the stator comprising:
a stator core;
an insulator covering the stator core; and
a resin portion covering the stator core and the insulator; wherein
the stator core includes:
a core back having an annular shape and provided about a central axis; and
a plurality of teeth each radially extending to one side in a radial direction from the core back;
the insulator includes a protruding portion provided at least on one side of the stator core in an axial direction, and protruding to the one side with respect to the stator core in the radial direction; and
at least a portion of a side surface of the protruding portion on the one side in the radial direction defines a portion of a surface of the stator.

2. The stator according to claim 1, wherein a circumferential length of the protruding portion is equal to or greater than 50% of a circumferential length of an end portion of the teeth on the one side in the radial direction.

3. The stator according to claim 1, wherein
the protruding portion includes a recessed portion receding axially from another side to the one side of the protruding portion in the axial direction; and
the recessed portion is filled with a portion of the resin portion.

4. The stator according to claim 3, wherein
the recessed portion extends in a circumferential direction;
the protruding portion includes a plurality of first ribs each extending in the radial direction; and
the plurality of the first ribs are located in the recessed portion.

5. The stator according to claim 4, wherein the first ribs are respectively provided at a first end portion and a second end portion of the recessed portion in the circumferential direction.

6. The stator according to claim 4, wherein the first ribs are provided between a first end portion and a second end portion of the recessed portion in the circumferential direction.

7. The stator according to claim 4, wherein in each of the teeth, a distance in the circumferential direction between a farther end portion of the first rib located at one circumferentially farthest position, and a farther end portion of the first rib located at another circumferentially farthest position, is equal to or greater than 50% of a circumferential length of an end portion of the teeth on the one side in the radial direction.

8. The stator according to claim 4, wherein
in each of the teeth, the first rib located at one circumferentially farthest position is closer to a center of the protruding portion in the circumferential direction than the first rib located at another circumferentially farthest position; and
a distance in the circumferential direction between the center of the protruding portion in the circumferential direction, and a farther end portion of the first rib located at the one circumferentially farthest position, is equal to or greater than 25% of a circumferential length of an end portion of the teeth on the one side in the radial direction.

9. The stator according to claim 1, wherein the protruding portion includes:
a joint portion extending to the one side in the axial direction and to the one side in the radial direction, at least from the one side of the stator core in the axial direction; and
a wall portion located along an end portion of the joint portion on the one side in the radial direction;
wherein
at least a portion of the wall portion is located on the one side with respect to the stator core in the radial direction; and
at least a portion of the side surface of the wall portion on the one side in the radial direction defines a portion of the surface of the stator.

10. The stator according to claim 9, wherein
the protruding portion includes a second rib extending to the one side in the axial direction from the joint portion; and
the second rib is connected to the wall portion on the one side in the radial direction.

11. The stator according to claim 9, wherein the wall portion has a rectangular shape when viewed in the radial direction.

12. The stator according to claim 9, wherein the wall portion has a trapezoidal shape including a short side on the one side and a long side on another side in the axial direction, when viewed in the radial direction.

13. The stator according to claim 1, wherein
the stator core includes a plurality of steel plates stacked in the axial direction to define a laminated structure; and
the stator includes a filler located between the steel plates, at an end portion of the laminated steel plates on the one side in the radial direction.

14. The stator according to claim 1, wherein the stator includes a cover film covering a side surface of the stator core, at least on the one side in the radial direction.

15. A motor comprising:
a rotor that rotates about a central axis; and
the stator according to claim 1 that drives the rotor.

16. An air blower comprising:
an impeller that rotates a vane about the axial direction; and
the motor according to claim 15 that drives the impeller.

17. A method of manufacturing the stator according to claim 1 using a mold, the method comprising:
placing the stator core covered with the insulator in the mold; and
covering the stator core and the insulator with the resin portion by injecting a resin material into the mold; wherein
the placing of the stator core includes bringing at least a portion of a side surface of the protruding portion of the insulator, on the one side in the radial direction, into contact with an inner wall of the mold.
